(19) United States
(12) Patent Application Publication
(10) Pub. No.: US 2006/0009092 A1
(43) Pub. Date: Jan. 12, 2006

(54) Electric water crafts

(76) Inventor: Mark Howard Krietzman, Palos Verdes Estates, CA (US)

Correspondence Address: Mark Krietzman, P.O. Box 3185, Palos Verdes, CA, 90274, US

(21) Appl. No.: 10/923,209

(22) Filed: Aug. 20, 2004

Related U.S. Application Data
(63) Continuation-in-part of application No. 10/374,477, filed on Feb. 25, 2003, now abandoned.
(60) Provisional application No. 60/497,282, filed on Aug. 22, 2003.

(51) Int. Cl. B60L 11/02

(52) U.S. Cl. 440/6

(57) ABSTRACT

An electric personal water craft. The electric personal water craft produces its own electricity from an on-board fuel cell system. Hydrogen fuel is stored or produced within the hull of the personal water craft. The heat produced by the fuel cell stack can dissipated to the water environment for heat management of the fuel cell power system. Output from the fuel cell system may also be stored in a rechargeable NiMH battery and used alone or in conjunction with the fuel cell to provide electricity for the electric propulsion. A photovoltaic array can be used to supplement the electricity for use and to recharge the battery

### RELATED APPLICATION

This patent application is a continuation-in-part of Applicant's Pending Patent Application entitled “Electric Personal Water Craft” Ser. No. 10/374,477 filed Feb. 25, 2003 which is incorporated herein by this reference. This patent application also claims the benefit of Applicant's provisional patent application entitled “Electric Personal Water Crafts” filed Aug. 22, 2003 60/497,282 which is hereby incorporated by this reference.

### BACKGROUND OF THE INVENTION

1. Field of the Invention

This present invention relates to an electric water craft with electricity supplied by a fuel cell stack. More specifically, to an electric propulsion system and method for an electric water craft.

2. Background Art

The personal water craft “PWC” is commonly known as a small marine vessel with limited seating. Prior art PWC's use an inboard internal combustion engine (ICE) to power a water jet pump. The PWC has limited hull space for electronics, fuel and propulsion systems.

The PWC can also be dirty and noisy. The PWC is the subject of restrictions in areas such as national parks (see 36 Code of Federal Regulations 13.63 (h) (i)). The majority of PWC's are powered by a two-stroke ICE which uses a mixture of gasoline and oil for fuel. Unfortunately, about one third of the oil and gasoline mixture is unburned and introduced into the surrounding environment. The California Air Resources Board (CARB) has reported that a days ride on a 100 horsepower PWC emits the same amount of smog as driving 100,000 miles in a modern automobile, see “Proposed Regulations for Gasoline Spark-Ignition Marine Engines, Draft Proposal Summary” Mobile Source Control Division, State of California Air Resources Board; Jun. 11, 1998.

PWCs are water crafts and they are highly maneuverable making them suitable for a variety of recreational, law enforcement and military activities. However, the noise and pollution problems of the ICE can limit their use. Some are constructed with two seats side by side with occupants surrounded by at least a partial hull, others place one or more riders on a raised hull section.

Electric motors have been used in small marine and water crafts for fishing and water taxis for slow speed propulsion, navigation and trolling. Electric motors have also been used as secondary low speed propulsion or for low speed navigation in marine crafts which have a primary propulsion provided by an ICE, see generally U.S. Pat. Nos. 6,305,994 and 6,361,385 issued to Bland et. al.

Conventional batteries (lead acid) have been used to supply electricity for low speed propulsion of marine water crafts. Conventional batteries are, however, bulky, heavy, and slow to recharge. An electric watercrafts or water taxi has limited weight load bearing capacity and often trade off cargo or passenger carrying capacity for battery carrying capacity. The water taxi is often used in busy commercial or recreational settings and may be in operation beyond the output capacity of a battery supply. This type of usage makes long recharge times, or recharge from the electric grid impractical and/or inconvenient. One costly alternative is to have multiple sets of water taxis with one group recharging while the other group is operational. Accordingly, conventional batteries are a poor choice to power an electric water craft or taxi. i

A Proton Exchange Membrane Fuel Cell “PEMFC” generates electricity through the passage of protons from hydrogen atoms through a membrane. The movement of the disassociated electrons around the membrane generates electricity. As shown in equation 1 (the anode half reaction) and equation 2 (the cathode half reaction).
H2>2H++2e− Equation 1
½O2+2H++2e−>H2O+Heat Equation 2

The heat generated during the passage of the electrons around the membrane and the formation of water at the cathode. The temperature for practical operation of the PEMFC is about 80 C to about 120 C However, the heat generated during operation, if not removed can cause the PEMFC to exceed 120C. With increased temperature the performance of the PEMFC can diminish. See generally U.S. Pat. No. 6,066,408 issued to Vitale and Jones. Accordingly, it would also be desirous to have a fuel cell power supply for a water craft with heat management.

It would therefore be desirous to have a water craft, with the primary propulsion system being electric, without a conventional battery power supply.

Additionally, a self-recharging electric water craft without a large heavy conventional battery supply would also be desired.

### SUMMARY OF INVENTION

Some exemplary implementations are an electric water craft (EWC) which includes fresh water and electric marine craft with a fuel cell providing electricity directly for the propulsion.

Some exemplary implementations are an EWC with a fuel cell providing electricity indirectly (via recharging a fast recharging battery) for propulsion.

Some exemplary implementations are an EWC with a fuel cell providing electricity directly and indirectly for propulsion.

Some exemplary implementations are an EWC a fuel cell providing electricity directly for non-propulsion electrical systems.

Some exemplary implementations are an EWC with a fuel cell providing electricity indirectly (via recharging a fast recharging battery) for non-propulsion electrical systems.

Some exemplary implementations are an EWC with a fuel cell providing electricity directly and indirectly for non-propulsion propulsion systems.

Some exemplary implementations are an EWC with a photovoltaic array supplying at least a portion of the electricity for propulsion.

Some exemplary implementations are an EWC with a photovoltaic array (solar powered) supplying at least a portion of electricity for battery recharging.

The electrical propulsion system for the EWC can use output from a fuel cell stack and/or photovoltaic array to recharge a battery supply. Weight can be reduced by utilizing fast recharging batteries such as a nickel-metal hydride battery “NiMH”, a nickel-cadmium battery “NiCd” battery or other fast recharging battery supply. Fast recharging small batteries can be recharged during the use of the EWC with electrical output from an on-board fuel cell stack and/or photovoltaic array during or in-between operation.

Electricity from the fuel cell and electrical output from a battery in some exemplary implementations power one or more electric motors. In such an implementation excess electricity produced by the fuel cell stack may also be used to recharge the battery.

Electricity from the photovoltaic array, the fuel cell and electrical output from a battery, in some exemplary implementations power one or more electric motors. In such an implementation excess electricity produced by the photovoltaic array and/or the fuel cell may also be used to recharge the battery.

Thermal management of a fuel cell stack is accomplished by heat exchange through at least a portion of the hull. Thermal management of the fuel cell stack also can reduce the interior hull temperature. Reducing the interior hull temperature also can reduce the temperature of other components within the hull.

For an EWC capable of high speed as few as one electric motor primary propulsion module may be used for the propulsion. A single impeller in a water tunnel can provide a water jet stream, exiting a discharge nozzle at the rear of the craft for propulsion. A directional nozzle affixed to the discharge nozzle can be used for navigation. The combination of a water tunnel, impeller and discharge nozzle form the main components of a water jet propulsion module. The directional nozzle is controllable by the user.

An EWC may have two or more electric motors for the primary propulsion. For a dual water jet EWC, with rearward discharge nozzles, navigation can be effected by controlling the discharge of water from either or both of the discharge nozzles and/or by adding controllable directional nozzles. A propulsion module may use conventional propellers on shafts rather than a water jet. Propellers on shafts may be preferred for low speed navigation and propulsion. Navigation of such propellers is controlled through conventional rudders, angulations of the propeller and/or control of the rotational direction and rotational speed of each propeller.

The EWC may have one or more rearward motors, and at least one forward motor. By controlling the output of each forward motor and/or the rearward motor, propulsion and navigation of the craft can be controlled.

Other features and advantages of the present invention will be set forth, in part, in the descriptions which follow and the accompanying drawings, wherein the preferred embodiments of the present invention are described and shown, and in part, will become apparent to those skilled in the art upon examination of the following detailed description taken in conjunction with the accompanying drawings or may be learned by practice of the present invention. The advantages of the present invention may be realized and attained by means of the instrumentalities and combinations particularly pointed out in the appended claims.

### BRIEF DESCRIPTION OF THE DRAWINGS

FIG. 1A is an external side view of an EWC.

FIG. 1B is a cut-away side view of the embodiment of FIG. 1A.

FIG. 1C is a bottom view of the embodiment of FIG. 1A.

FIG. 1D is a cut-away back view of the embodiment of FIG. 1A at line A-A.

FIG. 1E is a top view of the embodiment of FIG. 1A.

FIG. 2 is a block diagram of the major components of the power generation and propulsion system of an EWC.

FIG. 3A is a back view of a dual motor EWC.

FIG. 3B is a partial bottom view of the embodiment of FIG. 3A.

FIG. 3C is a top view diagram, showing a turn, of the embodiment of FIG. 3A.

FIG. 4 is a block diagram of power and navigation components for a dual motor EWC.

FIG. 5 is a partial bottom view of an alternate embodiment of a dual motor EWC.

FIG. 6 is a block diagram of power and navigation components for a dual motor EWC.

FIG. 7 is a bottom of another embodiment of a EWC.

FIG. 8 is a block diagram of power and navigation components for a triple motor EWC.

FIG. 9 is a block diagram of the major components of the power generation and propulsion system of an EWC.

FIG. 10 is a block diagram of the major components of the power generation and propulsion system of a AC powered EWC.

FIG. 11 is a block diagram of the major components of the power generation and propulsion system of a DC powered EWC.

FIG. 12 is an illustration of a EWC with photovoltaic array.

It should be appreciated that for simplicity and clarity of illustration, elements shown in the Figures have not necessarily been drawn to scale. For example, the dimensions of some of the elements are exaggerated relative to each other for clarity. Further, where considered appropriate, reference numerals have been repeated among the Figures to indicate corresponding elements.

### DETAILED DESCRIPTION OF PREFERRED EMBODIMENTS

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for claims and as a representative basis for teaching one skilled in the art to variously employ the present invention in virtually any appropriately detailed structure.

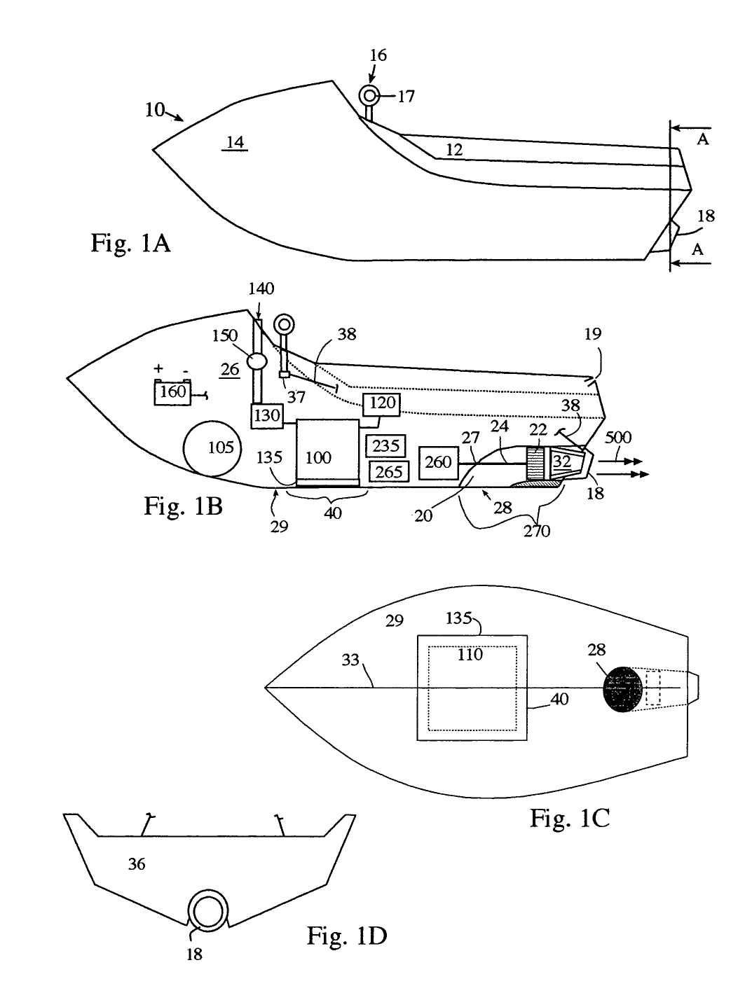

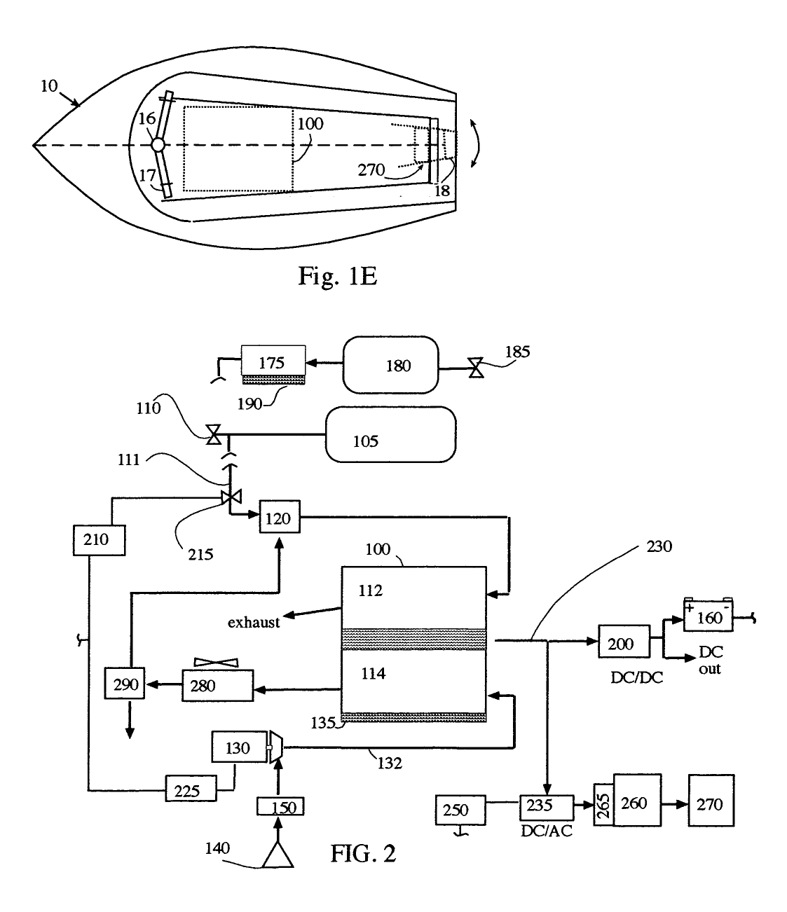

Shown in FIGS. 1A-1E is an electric water craft “EWC” 10. The EWC shown has a seat 12 raised above a hull 14, the hull 14 has hollow portions therein. A handle bar on a support 16 provides a hand hold for a rider. A hand grip control 17 can be mounted on the handle bar on a support 16. The hand grip control 17, in this embodiment, is a substantially a motorcycle-type hand throttle which is well known in the art. The hand grip control 17 is used for speed control.

A steering nozzle 18 extends from the back of the hull 14. An electric motor powered by electricity generated from the fuel cell provides the propulsion for the EWC. Those skilled in the art will recognize that the propulsion system for the EWC. shown in the figures is applicable to a small water craft which may have seating within a portion of the hull and/or which may use a steering wheel and lever throttle controls. Vents 19 are provided in the hull 14.

A schematic showing the major components of a fuel cell (FC), “electric water craft” (WC) is shown in FIG. 2. The components of the FC EWC are placed inside the hull 14 or extending therefrom. The “proton exchange membrane fuel cell stack” (PEMFC) 100 requires a supply of hydrogen to generate electricity.

Hydrogen is delivered to the PEMFC 100 from a hydrogen supply system. Many viable solutions of delivering hydrogen on-demand to a fuel cell tack exist. Those skilled in the art will recognize that most PEMFC work best and last longer when provided a stream of adequately humid substantially pure hydrogen. The source of the hydrogen is less important than the purity and humidity. Many chemical process can generated usable hydrogen from a chemical reaction, as can reformation or compressed and stored hydrogen. Chemical and reformation processes may require filtration or removal of compounds other than hydrogen to deliver a suitably pure hydrogen stream to the PEMFC.

In one exemplary implementation at least one refillable hydrogen storage tank 105 with a fill valve 110 connected to a pressure rated hydrogen feed line 111 through which hydrogen flows to the anodes 112 of a fuel cell stack is illustrated. Different PEMFC can utilize hydrogen at different pressure. Normally, as is known in the art, the pressure of the hydrogen dispensed from the tank 105 will be regulated by a pressure regulation device (not shown) and delivered to the anodes 112 at a pressure which is within the operating pressure for the membranes with in the anodes 112. The hydrogen storage tank should have a pressure rating of at least 1000 psi and more preferably a pressure rating of at least 5000 psi, and most preferably a pressure rating of at least 10,000 psi. The hydrogen feed line 111 passes into a humidity control device 120 which adds moisture to the gaseous hydrogen before it flows to the PEMFC 100.

An is delivered oxygen to the PEMFC 100 from an oxygen supply system. An air compressor 130 draws atmospheric air down an air intake 140 through a filter 150 and directs the compressed air, through an air feed line 132 to the cathode(s) 114 of the PEMFC 100. The air compressor 130 is connected to a battery 160 to initiate the air compressor 130 operation.

The PEMFC 100, a hydrogen supply system (which delivers pressurized humid hydrogen to the PEMFC 100) and an oxygen supply system which delivers pressurized oxygen to the PEMFC 100 working together may be referred to as a “fuel cell power system”. Those skilled in the art will recognize that additional or varied components which perform the same functions as the elements of the Hydrogen supply system or the oxygen supply system may be used as part of a fuel cell power system without departing form the intended scope of the invention herein.

Once the PEMFC 100 is operating (generating electricity) a direct current “DC” to DC (DC/DC) converter 200 may be used to step down the voltage and power on board systems such as the compressor 130 and other low voltage components, and to recharge the battery 160.

As indicated in equation 2 the operation of the PEMFC 100 generates heat. The PEMFC 100 is most efficient when operating between about 80 and about 120 C. By thermally connecting the PEMFC 100 with a fuel cell heat exchanger 135, through a heat exchange region 40 of the hull 14, to the water environment the heat from operating the PEMFC 100 can be dissipated, dispersed and/or managed. Heat exchangers are well known in the art. In this embodiment the heat exchanger 135 is a finned metallic portion. Other configurations and types of heat exchangers, coolers, or radiators may also be suitable.

As indicated many alternate hydrogen supply systems are known. Also shown in FIG. 2 is a reformer 175, which generally comprises a combustion chamber and a reaction chamber, is used to free gaseous hydrogen from a hydrogen rich fuel. The hydrogen rich fuel is supplied to the reformer 175 from an internal fuel tank 180. A fuel fill valve 185 is used to refill the fuel tank.

Reformers for generating hydrogen from hydrogen rich fuels are well represented in the art. No specific reformer is called out for. But rather, a reformer which can provide an adequate quantity of gaseous hydrogen to supply the consumption of the PEMFC 100. The reformation process is exothermic (heat producing) and a reformer heat exchanger 190 is shown in FIG. 2. The reformer heat exchanger 190 is used to thermally connect the reformer 175 to the marine environment (via a heat exchange region 40 of a hull as shown in FIG. 1C) to manage the heat generated by the reformer 175.

A fuel system controller 210 is used to control the on/off function of the hydrogen supply valve the 215 and the motor controller 225 for the compressor 130. In this embodiment electricity from the fuel cell stack is also received by an electric power inverter 235 with its own controller 250. The electric power inverter converts the DC output of the fuel cell power system to an alternating current “AC” to operate an AC electric motor 260 which drives the water jet propulsion module 270. In some instances a DC motor may be preferable. The description herein of an AC motor is preferred and not intended as a limitation.

The speed of the EWC can be controlled by varying the electrical output of the PEMFC 100. Some of the procedures to vary the output of the PEMFC 100 is altering the hydrogen flow (via the hydrogen supply valve 215) and/or varying the available oxygen (via altering the action of the compressor 130). The speed of the EWC can also be controlled by varying the output of the inverter 235 and/or varying the speed of the electric motor 260. The speed of the electric motor 260 is adjusted by the motor speed control 265.

The size, current requirements, and electrical output of the electric motor 260 are dependent on the intended to usage of the FC EWC. An FC EWC for a single rider may require a less powerful motor than a FC EWC for two or more riders. A high speed EWC for 1 to 4 riders may require more output than a low speed EWC, such as a water taxi for 12 riders.

Components of the water jet propulsion module 270, shown in FIG. 1B, are a water tunnel 20, an impeller 22 (connected to a motor shaft 24 which extends from inside the hull 26, through a sealed guide 27, into the water tunnel 20), a tunnel opening 28 through the bottom of the hull 29, and a discharge nozzle 32.

The AC electric motor 260, with motor speed controller 265, provides the primary propulsion for the EWC. The electric power inverter 235 provides the AC current. When the impeller 22 inside the water tunnel 20 rotates water is directed through the water tunnel 20 and forms a stream of water. The stream of water reaches the discharge nozzle 32 and exits the EWC. In this embodiment a steering nozzle 18 is connected to the discharge nozzle whereby the stream of water is movably directed. The discharge nozzle 32, in this embodiment, is placed near the centerline of the EWC 33 and at the backside of the hull 36. The stream of water passes through the steering nozzle and a water jet stream 500 exits. By controlling the direction of the water jet stream 500, relative to the EWC, the steering nozzle 18 is used in propulsion and navigation of the EWC.

The steering nozzle 18 is physically controlled by the movement of the handle bars on a support 16. An actuator 37 is connected to the handle bars on a support 16 and the steering nozzle 18. Known in the art are many types of actuators including but not limited to wire-actuators, mechanical, electrical and hydraulic. Accordingly, a detailed description of an actuator is not provided. The actuator 37, in this embodiment with a linking rod 38, connects the handle bars 16 to the steering nozzle 18. Any actuator which react to the movement of the handle bars 16 and will provide a corresponding movement of the steering nozzles 18 can be used without departing from the scope of this invention.

The fuel cell heat exchanger 135 is in thermal contact with a heat exchange region 40 of the bottom of the hull 29. If a reformer 175 is being used to provide hydrogen, a reformer heat exchanger 185 can also be placed in contact with the heat exchange region 40. The heat exchange region 40 is constructed with good thermal conducting properties whereby the heat from the operation of the PEMFC 100 is dissipated into the marine environment. The heat exchange region 40, at its interface 41 with the hull bottom 29, should be constructed to avoid heat damage to itself, the hull, or the interface 41. The heat exchange region 40 may be constructed with channels, fins or have other surface features, which are known in the art, to increase the surface area for heat exchange. In the present embodiment a metallic material, such as stainless steel can be used to construct the heat exchange region 40. However, it is within the scope of this disclosure that other metallic and non-metallic materials, such as metal alloys, resins, composites, insert molded metal and plastic, and ceramics may be used to form at least a part of the heat exchange region.

Other components connect to the fuel cell power system include, but are not limited to, the water management which is shown in this embodiment as a condenser 280 which receives an exhaust stream from the cathode and condenses the water therein. The condenser 280 can provide water for use in the humidity control device 120. The condensed water can be stored in a reservoir 290. In some embodiments a DC/DC converter may be connected to the fuel cell power system, in other embodiments a power inverter 235 may be used to covert the DC to AC.

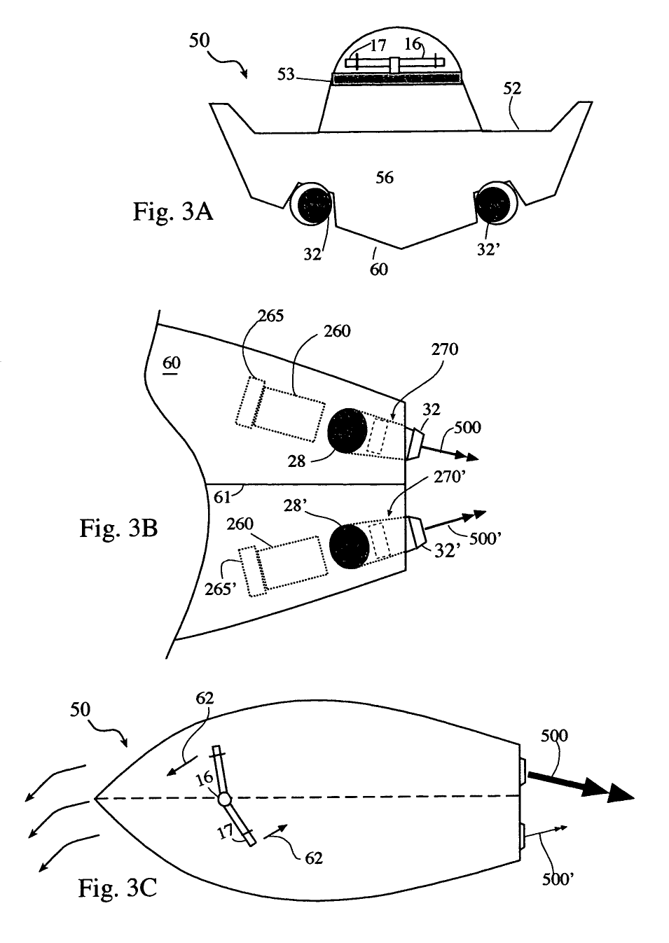

In FIGS. 3A and 3B the FC EWC 50 also has a hull 52 with a seat 53. Dual fixed discharge nozzles 32 & 32′, extend through the back of the hull 56. The dual fixed discharge nozzles 32 & 32′ are shown at a fixed angled with the water jet stream 500 & 500′ directed towards the centerline 61 of the hull 60. The first and second electric motors 260 & 260′ are each connected to a water jet propulsion module 270 and generally operates as described in reference to the embodiment described in FIGS. 1A-1E.

In this embodiment the water jet streams 500 & 500′ exits each water tunnel the discharge nozzles 32 & 32′. Weight shifting and varying the volume of discharged water in each of the water jet streams 500 & 500′ provide the propulsion and navigation. The volume of discharged water in a water jet stream is a time measurement. By varying the volume of water discharged over a period of time the EWC can be navigated, as shown in FIG. 3C.

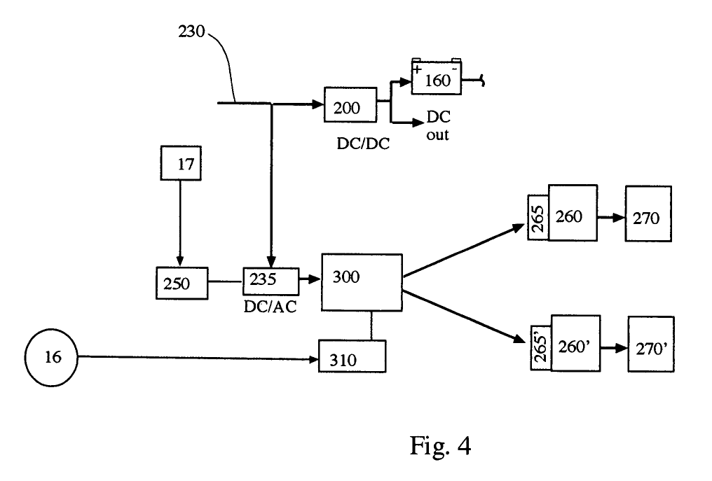

A load splitter 300, shown in FIG. 4 receives the electrical output from the inverter 235. The load splitter can divide up the power directed to each motor 260 & 260′. The load splitter 300 is controlled by a load splitter controller 310. The PEMFC 100 within the fuel cell power supply, supplies the current to the inverter 235. In this embodiment the movement of the handle bars 16 communicates with the load splitter controller 310 to vary the power to each motor 260 & 260′.

To turn the EWC left (shown in FIG. 3C) a user moves the handle bars 16 along the direction of arrow 62. The handle bar 16 movement communicates with the load splitter controller which directs the load splitter 300 to increases the electrical output to the right motor 260 as compared to the electrical output to the left motor 260′. The change in output to the electrical motors 260 & 260′ causes a change in the volume of discharged water in the water jet streams 500 & 500′. A rider can increase or decrease the forward speed of the EWC by adjustment of the total electrical output provided to the load splitter 300, via the hand grip 17.

Electric motor(s) 260 can also power a propeller (not shown) extending from a hull. The use of the aforementioned water jet propulsion module (an impeller in a water tunnel with a discharge nozzle) to produce a water jet stream for propulsion is not a limitation of this invention. A propeller connected to a motor shaft can be used to provide propulsion and navigation to a fuel cell powered electric water craft. An impeller is preferred for those EWCs which have a rider above the hull, such a EWC can have riders approaching the EWC from the water and or falling off the EWC the impeller eliminates the risk of injury from a propeller.

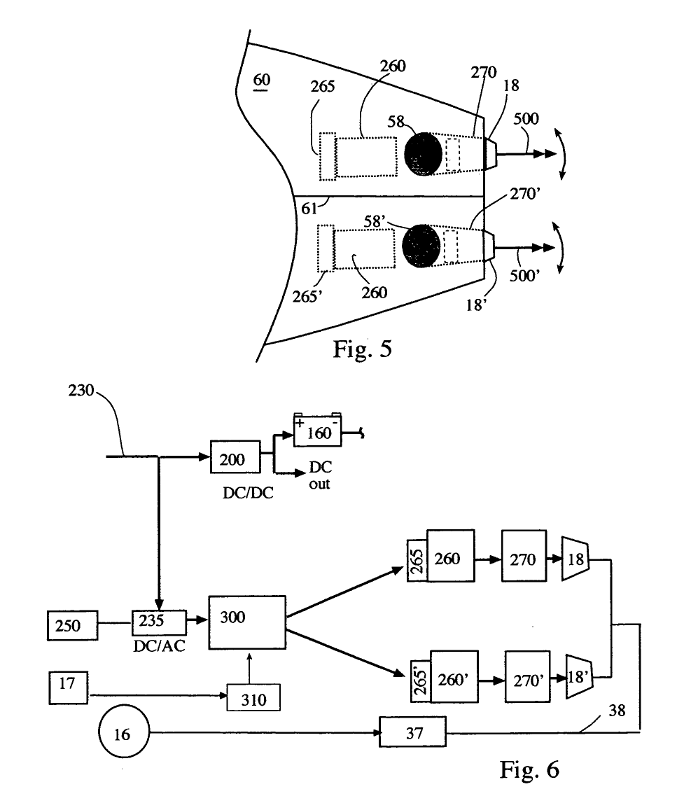

A dual motor EWC with dual with dual steerable nozzles 18 & 18′ is shown in FIGS. 5 & 6. In this embodiment the load splitter 300 provides equal electrical output to each motor 260 & 260′. Navigation is by the same general mechanism described in reference to the embodiment shown in FIG. 1A-1E. The steering nozzles 18 & 18′ are located on either side of the centerline 61 and move together. The steering nozzles are physically connected to each water jet propulsion module 270. The steering nozzles 18 & 18′ are controlled by the movement of the handle bars 16 which is connected to an actuator 37.

The load splitter 300, in this embodiment, splits the load substantially evenly (generally to produce the same RPM per motor) between each motor 260 & 260′.

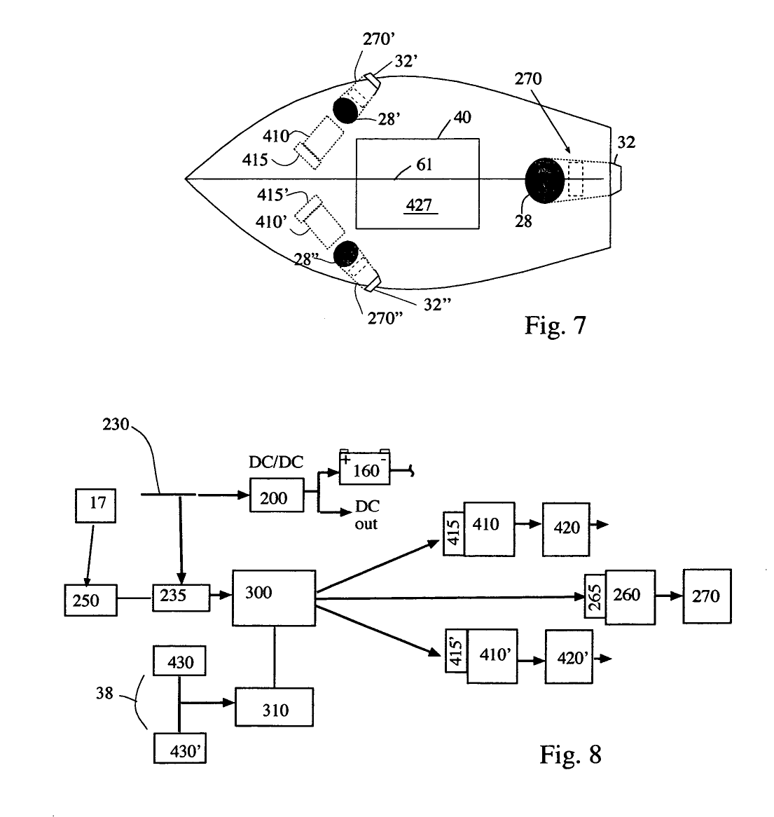

A triple electric motor EWC 70 is shown in FIGS. 7 & 8. In this embodiment the load splitter 300 provides electrical output to the rear motor 260 (and rearward water jet propulsion module 270) and to the two forward steering motors 410 & 410′. The forward steering motors 410 & 410′, each with a motor controller 415 & 415′, are angled away from the center line 61 and each is connected to a forward water jet propulsion module 420 & 420′. In this embodiment the forward steering motors and/or the propulsion modules 420 & 420′ are primarily for navigation and need not be of a size or output for primary propulsion. The jet propulsion modules 270, 420 and 420′ indicated may be replaced with propeller modules. Propeller modules are preferred for low speed propulsion and navigation in crafts such as water taxis.

As previously described, a load splitter 300 operates to direct a portion of the electricity from the PEMFC 100 (which is a part of the fuel cell power system) to the different motors. Specifically, to the rear motor 260 and the forward steering motors 410 & 410′, as needed. To steer the EWC left a rider (not shown) engages an actuator 37 which communicates with the load splitter controller 310 to power the right forward steering motor 410′. The propulsion modules 27

In this embodiment the actuator is an actuator system which communicates with the load splitter controller 310 comprises dual foot controls 430 & 430′. In this embodiment the foot controls 430 & 430′ actuates the load splitter controller 310. The foot controls may be mechanical, hydraulic, or “by-wire” (electrical). To turn the EWC left a rider (not shown) places uneven pressure on the dual foot controls, with more pressure on the left foot control 430, the change in pressure on the left foot control 430 actuates the load splitter controller 310 and the load splitter 300 increase the electrical output to the right forward steering motor 410′. A rider can increase or decrease the forward of the EWC by adjustment of the total electrical output provided to the load splitter 300, via the hand grip 17. The foot controls 430 & 430′ could also be used to control a mechanical actuator to control steering nozzles.

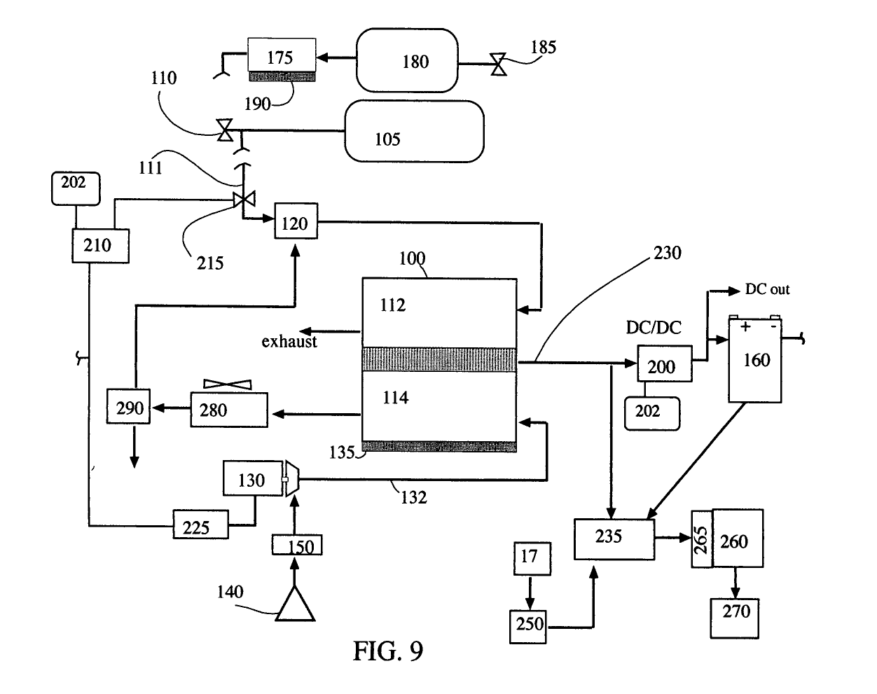

Shown in FIG. 9 is a schematic for the major components of a system and method for another FC EWC. The components of the FC EWC are placed inside the hull 14 or extending therefrom. The hydrogen may be provided from any suitable source. Shown in this implementation is a hydrogen supply system to the PEMFC 100 from a refillable hydrogen storage tank 105 with a fill valve 110 connected to a pressure rated hydrogen feed line 111 which is connected to the anode(s) 112 of the fuel cell stack. The hydrogen storage tank should have a pressure rating of at least 1000 psi and more preferably a pressure rating of at least 5000 psi, and most preferably a pressure rating of at least 10,000 psi.

During operation of the fuel cell power system, the hydrogen feed line 111 passes through a humidity control device 120 to add moisture to the gaseous hydrogen before it flows to the PEMFC 100. An oxygen supply system provides oxygen to the PEMFC 100. As previously described the air compressor 130 draws atmospheric air down an air intake 140 through a filter 150 and directs the compressed air, through an air feed line 132 to the cathode(s) 114 of the PEMFC 100. The air compressor 130 is connected to a battery 160 to initiate the air compressor 130 operation. Vents 19 are provided in the hull.

Once the fuel cell power system (and the PEMFC 100 therein) is operating (generating electricity) a DC/DC converter 200 is used to step down the voltage and power on board systems such as the compressor 130 and other low voltage components, and recharge the battery 160, which in this embodiment is preferably a NiMH battery or other fast recharging battery.

The NiMH battery 160 or other fast charging battery can be used as a co-primary power supply along with the electricity generated from the output of the PEMFC 100 with a portion of the electricity for the motors supplied by the battery 160 and a portion of the electricity supplied from the PEMFC 100.

The NiMH battery or other fast charging battery 160 can be used as the primary power supply for the propulsion with the battery 160 recharged by the output of the PEMFC 100, of the fuel cell power system, via the DC/DC converter 200. A battery 160 refers to a suitable size battery power supply which may be a single battery or multiple batteries connected in series or parallel, depending on the power requirements of the water craft and/or the propulsion system.

A sensor 202 may be added to monitor the recharging of the battery 160. The sensor 202, when connected to the fuel system controller 210 (not shown) can be used to control the recharging of the battery 160 via the available electrical output from the PEMFC 100. The sensor 202, when connected to the DC/DC converter 200 can be used to control the recharge rate of the battery 160. The sensor may be connected to both the fuel system controller 210 and the DC/DC converter.

As indicated in equation 2 the operation of the PEMFC 100 generates heat. The PEMFC 100 is most efficient when operating between about 80 and about 120 C. By thermally connecting the PEMFC 100 with a fuel cell heat exchanger 135, through a heat exchange region 40 of the hull 14, to the marine environment the heat from operating the PEMFC 100 can be dissipated, dispersed and/or managed. Heat exchangers are well known in the art. In this embodiment the heat exchanger 135 is a finned metallic portion. Other configurations and types of heat exchangers, coolers, or radiators may also be suitable.

An alternate hydrogen supply is also shown in FIG. 2. A reformer 175, which generally comprises a combustion chamber and a reaction chamber, is used to free gaseous hydrogen from a hydrogen rich fuel. The hydrogen rich fuel is supplied to the reformer 175 from an internal fuel tank 180. A fuel fill valve 185 is used to refill the fuel tank.

Reformers for generating hydrogen from hydrogen rich fuels are well represented in the art. No specific reformer is called out for. But rather, a reformer which can provide an adequate quantity of gaseous hydrogen to supply the consumption of the fuel cell stack 100. The reformation process is exothermic (heat producing) and a reformer heat exchanger 190 is shown in FIG. 2. The reformer heat exchanger 190 is used to thermally connects the reformer 175 to the marine environment (via a heat exchange region 40 of the EWC hull shown in FIG. 1C) to manage the heat generated by the reformer 175.

A fuel system controller 210, is used to control the on/off function of the hydrogen supply valve the 215 and the compressor 130 motor controller 225. Electricity from the fuel cell stack is also received by an electric power inverter 235 with its own controller 250. The electric power inverter converts the DC voltage from the PEMFC 100 to AC voltage to operate an AC electric motor 260, with a speed controller motor, which drives the water jet propulsion module 270. In some instances a DC motor may be preferable. The illustration of an AC motor is not a limitation. Those skilled in the art will recognize that the DC/AC inverter may be by-passed or removed and the DC, conditioned through a DC/DC converter to provide the correct voltage to DC motor(s), in place of the AC motor(s).

In this embodiment the power inverter controller 250 is used to manage the available DC from the PEMFC 100, the battery 160 or both the PEMFC 100 (of the fuel cell power system) and battery 160.

In a DC implementation the inverter is not required, but rather the DC/DC converter can be used to provide DC at the appropriate level for DC propulsion. In a hybrid fuel cell/battery EWC implementation the output available from the battery 160 may also need to be conditioned to meet the DC needs of the DC motor(s). A controller can manage what proportion of DC supplied to the motor is from the PEMFC 100 and what proportion is from the battery 160. The PEMFC may supply between 0 and about 100% of the electricity to the electric motor, The battery 160 may supply between 0 and about 100% of the electricity to the electric motor.

The speed of the EWC can be controlled by varying the electrical output of the fuel cell stack 100 and/or the flow of power from the battery 160. The output of the fuel cell stack 100 can be varied by altering the hydrogen flow, via the hydrogen supply valve and/or altering the action of the compressor 130 and thereby varying the available oxygen. The speed of the EWC can also be controlled by varying the output of the inverter 235 and/or varying the speed of the electric motor 260. The speed of the electric motor 260 is adjusted by the motor speed control 265.

The size, current requirements, and output (Kilowatts) of the electric motor 260 are dependent on the intended to usage of the FC EWC. An FC EWC for a single rider may require a less powerful motor than a FC EWC for two or more riders. An EWC with a 6-7 knot maximum speed has different electrical output requirements than a EWC operating at 25 knots. A PEMFC with a nominal output of as little as about 1 kilowatts may be sufficient to recharge the battery 160. Those skilled in the art will recognize that depending on the type of battery to be recharged, the current requirements of the motor, the weigh, water conditions, and the performance requirements of the EWC a PEMFC with a nominal output above 1 kilowatts may be preferred.

Components of the water jet water jet propulsion module 270, shown in FIG. 1B, are a water tunnel 20, an impeller 22 (connected to a motor shaft 24 which extends from inside the hull 26, through a sealed guide 27, into the water tunnel 20), a tunnel opening 28 through the bottom of the hull 29, and a discharge nozzle 32.

The AC electric motor 260, with motor speed controller 265, provides the primary propulsion for the EWC. The electric power inverter 235 provides the AC current. When the impeller 22 inside the water tunnel 20 rotates water is directed through the water tunnel 20 and forms a stream of water. The stream of water reaches the discharge nozzle 32 and exits the EWC. In this embodiment a steering nozzle 18 is connected to the discharge nozzle whereby the stream of water is movably directed. The discharge nozzle 32, in this embodiment, is placed near the centerline of the EWC 33 and at the backside of the hull 36. The stream of water passes through the steering nozzle and a water jet stream 500 exits. By controlling the direction of the water jet stream 500, relative to the EWC, the steering nozzle 18 is used in propulsion and navigation of the EWC.

The steering nozzle 18 is physically controlled by the movement of the handle bars on a support 16. An actuator 37 is connected to the handle bars on a support 16 and the steering nozzle 18. Known in the art are many types of actuators including but not limited to wire-actuators, mechanical, electrical and hydraulic. Accordingly, a detailed description of an actuator is not provided. The actuator 37, in this embodiment with a linking rod 38, connects the handle bars 16 to the steering nozzle 18. Any actuator which react to the movement of the handle bars 16 and will provide a corresponding movement of the steering nozzles 18 can be used without departing from the scope of this invention.

The fuel cell heat exchanger 135 is in thermal contact with a heat exchange region 40 of the bottom of the hull 29. If a reformer 175 is being used to provide hydrogen, a reformer heat exchanger 185 can also be placed in contact with the heat exchange region 40. The heat exchange region 40 is constructed with good thermal conducting properties whereby the heat from the operation of the PEMFC 100 is dissipated into the water environment. The heat exchange region 40, at its interface 41 with the hull bottom 29, should be constructed to avoid heat damage to itself, the hull, or the interface 41. The heat exchange region may be constructed with channels, fins or have other surface features, which are known in the art, to increase the surface area for heat exchange. In the present embodiment a metallic material, such as stainless steel can be used to construct the heat exchange region 40. However, it is within the scope of this disclosure that other metallic and non-metallic materials, such as metal alloys, resins, composites, insert molded metal and plastic, and ceramics may be used to form at least a part of the heat exchange region.

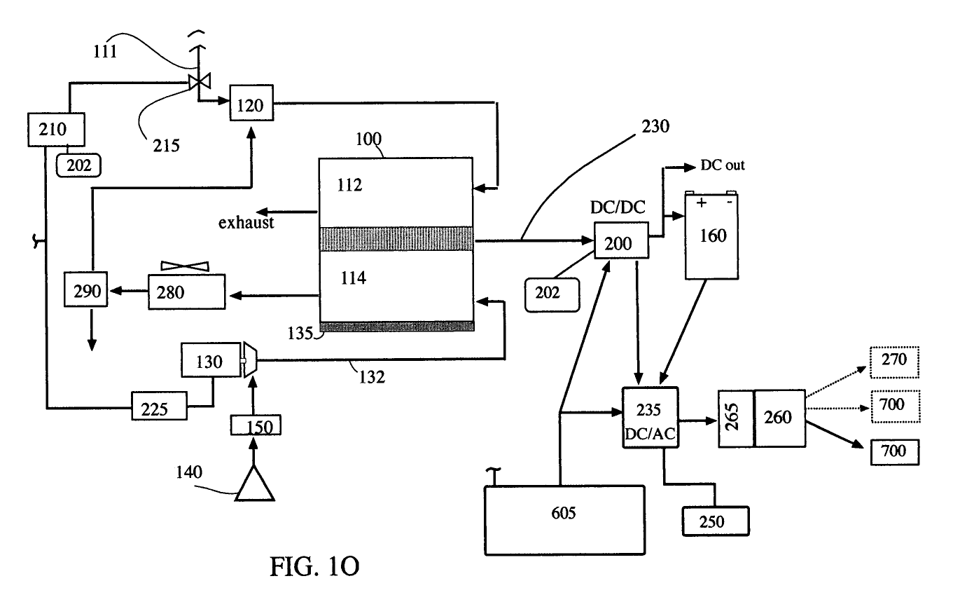

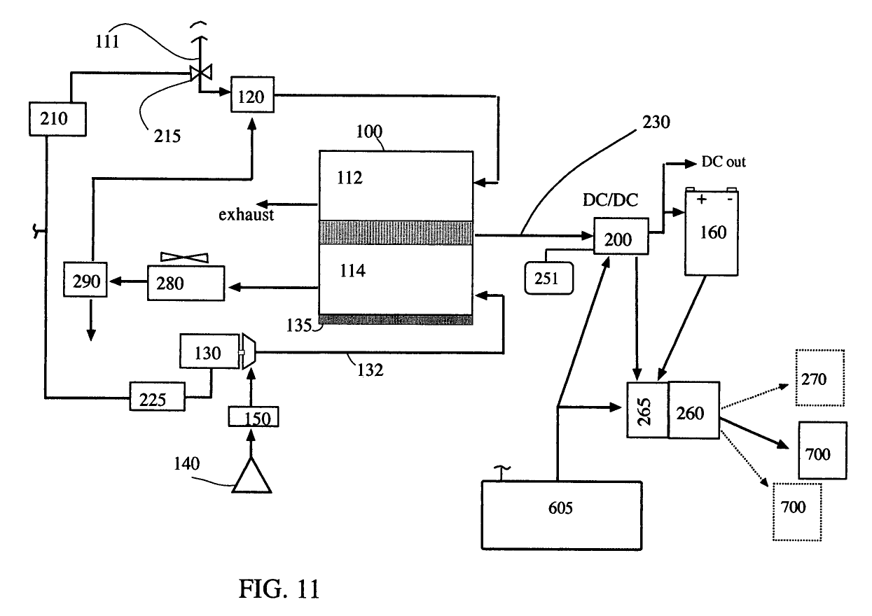

Shown in FIG. 10 is a schematic for the major components of a system and method for another FC EWC. The components of the FC EWC are placed inside a hull 14 or extending therefrom. The hydrogen may be provided from any suitable source to a pressure rated hydrogen feed line 111 which is connected to the anode(s) 112 of the fuel cell stack.

During operation of the fuel cell power system, the hydrogen feed line 111 may pass through a humidity control device 120 to add moisture to the gaseous hydrogen before it flows to the PEMFC 100. If the hydrogen stream is derived from a source which provides humid hydrogen the humidly control device 120 may be by-passed. An oxygen supply system provides oxygen to the PEMFC 100. As previously described the air compressor 130 draws atmospheric air down an air intake 140 through a filter 150 and directs the filtered compressed air, through an air feed line 132 to the cathode(s) 114 of the PEMFC 100. The air compressor 130 is connected to a battery 160 to initiate the air compressor 130 operation. Vents 19 are provided in the hull.

Once the fuel cell power system (and the PEMFC 100 therein) is operating (generating electricity) a DC/DC converter 200 is used to step down the voltage and power on board systems such as the compressor 130 and other low voltage components, and recharge the battery 160, which in this embodiment is preferably a NiMH battery or other fast recharging battery.

A photovoltaic array 605 utilizing connected photovoltaic thin films or cells can be added to provide additional electrical current. The current may be used for a portion of the propulsion, running non-propulsion electronics, and/or for recharging the battery 160. The photovoltaic array is shown connected to the DC/DC converter 200 before supplying electricity to the battery 160. Depending on the output of the photovoltaic array the need to step-down the voltage may not be required and the DC/DC converter 200 may be by-passed. The photovoltaic array 605 may also supply electricity directly to the inverter 235 for use by the electric motor 260.

In FIG. 10 the electrical output from the PEMFC is shown conditioned by the DC/DC converter 200 before being provided to the inverter 235 for use by the electric motor 260. Although one electric motor is shown 260 multiple electric motors may be used as described in other implementations. The electric motor drives a water jet propulsion module 270 or a propeller and shaft propulsion module 700.

In FIG. 11 the electrical output from the PEMFC is shown conditioned by the DC/DC converter 200 before being provided directly for use by the DC electric motor 260. A controller 251 ,ay be used to vary the available DC output provided by the DC/DC converter 200.

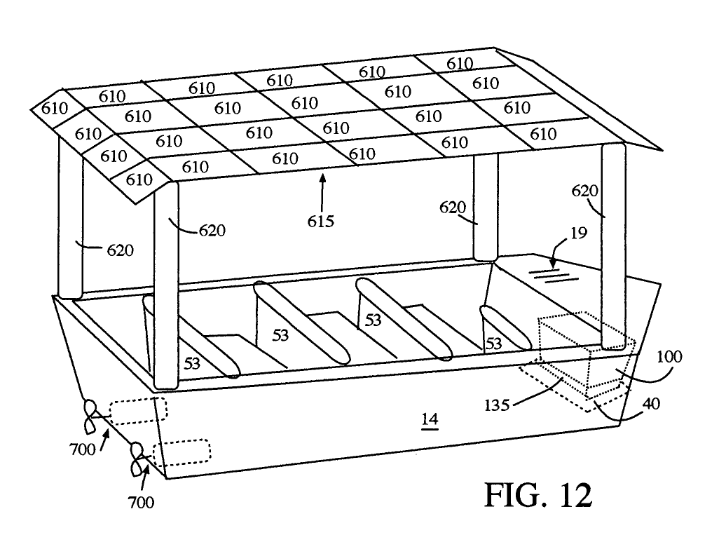

FIG. 12 shows a water taxi EWC with propulsion modules having propellers on shafts 700 and a photovoltaic array 605 consisting of connected cells or thin films 610 supported on a raised canopy 615 on canopy supports 620. The PEMFC is within the hull and thermal management is through a heat exchange region 40 of the hull 14, to the water environment. Thereby the heat from operating the PEMFC 100 can be dissipated, dispersed and/or managed. In this embodiment the fuel cell heat exchanger 135 is a finned metallic portion. Other configurations and types of heat exchangers, coolers, or radiators may also be suitable.

The NiMH battery 160 or other fast charging battery can be used as a co-primary power supply for the electric motor 260 along with electricity generated from the output of the PEMFC 100 and/or the electricity generated form the photovoltaic array 605.

The NiMH battery or other fast charging battery 160 can be used as the primary power supply for the propulsion with the battery 160 recharged by the output of the PEMFC 100 and/or the output form the photovoltaic array 605. A battery 160 refers to a suitable size battery power supply which may be a single battery or multiple batteries connected in series or parallel, depending on the power requirements of the water craft and/or the propulsion system.

A sensor 202 may be added to monitor the recharging of the battery 160. The sensor 202, when connected to the fuel system controller 210 can be used to control the recharging of the battery 160 via the available electrical output from the PEMFC 100. The sensor 202, when connected to the DC/DC converter 200 can be used to control the recharge rate of the battery 160. The sensor may be connected to both the fuel system controller 210 and the DC/DC converter.

Since certain changes may be made in the above apparatus without departing from the scope of the invention herein involved, it is intended that all matter contained in the above description, as shown in the accompanying drawing, shall be interpreted in an illustrative, and not a limiting sense.

I claim:

1. An electrical power system for the propulsion of an electric water craft comprising:
a water craft with a hull;
a PEMFC;
a source of hydrogen, whereby hydrogen is available for use by the PEMFC;
a source of oxygen, whereby oxygen is available for use by the PEMFC;
a rechargeable battery to be recharged from at least a portion of the output of the PEMFC; and
at least one propulsion module to receive electrical power provided by at least one of the PEMFC and the rechargeable battery.

2. The electrical power system of claim 1 wherein the hydrogen source further comprises at least one pressurized hydrogen storage tank.

3. The electrical power system of claim 1 wherein the hydrogen source further comprises a chemical process.

4. The electrical power system of claim 1 further comprising a DC/DC converter through which electrical power from at least one of the PEMFC and the battery is converted to a selected direct current.

5. The electrical power system of claim 1 further comprising an inverter through which electrical power from at least one of the PEMFC and the battery is converted to a selected converted to a selected alternating current

6. The electrical power system of claim 1 further comprising;
an inverter through which electrical power from at least one of the PEMFC and the battery is converted to a selected converted to a selected alternating current; and,
a DC/DC converter through which electrical power from at least one of the power from at least one of the PEMFC and the battery is converted to a selected direct current.

7. The electrical power system of claim 1 further comprising a controller whereby the recharging of the battery from the electricity produced by the PEMFC is controlled.

8. The electrical power system of claim 1 further comprising a through the hull to the water environment heat exchange means.

9. The electrical power system of claim 8 wherein the through the hull heat exchange means is a fuel cell heat exchanger thermally connected to a heat exchange region in the hull.

10. The electrical power system of claim 1 further comprising at least one controller whereby the flow of electricity to the propulsion module can be varied.

11. The electrical power system of claim 1 further comprising an inverter through which electrical power from at least one of the rechargeable battery and the PEMFC is converted to a selected AC.

12. An electrical power system for the propulsion of an electric water craft comprising:
a water craft with a hull;
a PEMFC;
a source of hydrogen, whereby hydrogen is available for use by the PEMFC;
a source of oxygen, whereby oxygen is available for use by the PEMFC;
a rechargeable battery to be recharged from at least a portion of the output of the PEMFC;
a photovoltaic array; and
at least one propulsion module to receive electrical power provided by at least one of the PEMFC, photovoltaic array and the rechargeable battery.

13. The electrical power system of claim 12 further comprising a DC/DC converter through which electrical power from at least one of the PEMFC, photovoltaic array and the battery is converted to a selected direct current.

14. The electrical power system of claim 1 further comprising an inverter through which at the electrical power from at least one of the PEMFC, photovoltaic array and the battery is converted to a selected alternating current.

15. The electrical power system of claim 12 further comprising;
an inverter through which electrical power from at least one of the PEMFC photovoltaic array and the battery is converted to a selected converted to a selected alternating current; and,
a DC/DC converter through which electrical power from at least one of the power from at least one of the PEMFC, photovoltaic array and the battery is converted to a selected direct current.

16. The electrical power system of claim 12 further comprising a controller whereby the recharging of the battery from the electricity produced by at least one of the PEMFC and photovoltaic array is controlled.

17. The electrical power system of claim 12 further comprising a through the hull to the water environment heat exchange means.

18. The electrical power system of claim 17 wherein the through the hull heat exchange means is a fuel cell heat exchanger thermally connected to a heat exchange region in the hull.

19. The electrical power system of claim 2 further comprising at least one controller whereby the flow of electricity to the propulsion module can be varied.

20. An electrical water craft comprising:
a water craft with a hull;
a PEMFC;
a source of hydrogen, whereby hydrogen is available for use by the PEMFC;
a source of oxygen, whereby oxygen is available for use by the PEMFC;
a rechargeable battery to be recharged from at least a portion of the output of the PEMFC;
a photovoltaic array;
at least one controller whereby the flow of electricity to the propulsion module can be varied;
at least one of an inverter and a DC/DC converter; and
at least one propulsion module to receive electrical power provided by at least one of the PEMFC, photovoltaic array and the rechargeable battery.
